(19) United States
(12) Patent Application Publication
(10) Pub. No.: US 2014/0292684 A1
(43) Pub. Date: Oct. 2, 2014

(54) INFORMATION PROCESSING APPARATUS AND CONTROL METHOD OF INFORMATION PROCESSING APPARATUS

(71) Applicant: FUJITSU LIMITED, Kawasaki-shi (JP)

(72) Inventors: Shuichi SHIITANI, Machida (JP); Yoku TAKAHASHI, Minato (JP); Isamu SHIDA, Kawasaki (JP); Yasuji OTA, Yokohama (JP)

(73) Assignee: FUJITSU LIMITED, Kawasaki-shi (JP)

(21) Appl. No.: 14/188,406

(22) Filed: Feb. 24, 2014

(30) Foreign Application Priority Data
Mar. 29, 2013 (JP) 2013-072685

(51) Int. Cl. G06F 3/01

(52) U.S. Cl. CPC G06F 3/017
USPC 345/173

(57) ABSTRACT

An information processing apparatus causes, upon accepting a switching instruction, an event controller to switch a notification destination from a first process to a second process. The first process is run by execution of an application program that is related to a screen image currently displayed on a touch panel. The second process is run by execution of the control program. The information processing apparatus displays, upon being notified of a movement event from the event controller, the screen image at a shifted position on the touch panel. The information processing apparatus transfers, upon being notified of a first touch event from the event controller, a second touch event to the first process. The second touch event is obtained by adjusting the first touch event such that a touch position included in the first touch event is modified based on the movement vector.

### CROSS-REFERENCE TO RELATED APPLICATION

This application is based upon and claims the benefit of priority from the prior Japanese Patent Application No. 2013-072685 filed on Mar. 29, 2013, the entire contents of which are incorporated herein by reference.

### FIELD

The embodiments discussed herein are related to an information processing apparatus and a control method of the information processing apparatus.

### BACKGROUND

There is a trend that the size of a screen of a smartphone is increased. When a user operates a smartphone employing a large-size screen with one hand, there exists an area on the screen where it is difficult for the user to touch with a finger of the hand holding the smartphone.

FIG. 1 illustrates an exemplary screen image of a mobile terminal device. The rectangular shape on the upper side of a screen image 101 shown on a display indicates an area of software button 103 such as an icon. When the user holds the smartphone with the one hand and operates the touch panel with a thumb of the hand, it is difficult for the user to touch the icon and the like that are shown on upper area as illustrated in FIG. 1.

Related techniques are disclosed, for example, in Japanese Laid-open Patent Publication No. 6-004208, Japanese National Publication of International Patent Application No. 2010-515978, and Japanese Laid-open Patent Publication No. 2010-033413.

### SUMMARY

According to an aspect of the present invention, an information processing apparatus causes, upon accepting a switching instruction, an event controller to switch a notification destination from a first process to a second process. The switching instruction is an instruction for switching a mode of the information processing apparatus to a scroll mode. The notification destination is a destination to which a panel event is to be notified of. The panel event is raised in response to an operation on the touch panel. The first process is run by execution of an application program that is related to a screen image currently displayed on a touch panel. The second process is run by execution of the control program. The information processing apparatus displays, upon being notified of a movement event from the event controller, the screen image at a shifted position on the touch panel. The movement event is a panel event raised in response to an operation of dragging or flicking on the touch panel. The shifted position is obtained by shifting an original position in accordance with a movement vector resulted from the movement event. The original position is a position at which the screen image is currently displayed on the touch panel. The information processing apparatus transfers, upon being notified of a first touch event from the event controller, a second touch event to the first process. The first touch event is a panel event raised in response to an operation of touching the touch panel. The second touch event is obtained by adjusting the first touch event such that a touch position included in the first touch event is modified based on the movement vector.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary screen image of a mobile terminal device;

FIG. 2 is a diagram illustrating an exemplary operation of the mobile terminal device;

FIG. 3 is a diagram illustrating an exemplary operation of the mobile terminal device;

FIG. 4 is a diagram illustrating an exemplary hardware configuration of the mobile terminal device;

FIG. 5 is diagram illustrating an exemplary functional configuration of the mobile terminal device;

FIG. 6 is a diagram illustrating an exemplary sequence of normal mode start-up;

FIG. 7 is a diagram illustrating an exemplary sequence of a drawing operation in a normal mode;

FIG. 8 is a diagram illustrating an exemplary sequence of a touch operation in the normal mode;

FIG. 9 is a diagram illustrating an exemplary configuration of a scroll control class;

FIG. 10 is a flow chart illustrating an example of a scroll control processing;

FIG. 11 is a diagram illustrating an exemplary sequence of scroll mode start-up;

FIG. 12 is a diagram illustrating an example of a screen image that is stored in a frame buffer;

FIG. 13 is a diagram illustrating an example of a screen image that is stored in an image buffer;

FIG. 14 is a diagram illustrating an exemplary sequence of a scroll operation in the scroll mode;

FIG. 15 is a diagram illustrating the outline of image position adjustment;

FIG. 16 is a diagram illustrating an exemplary sequence of a drawing operation in the scroll mode;

FIG. 17 is a diagram illustrating an exemplary sequence of a touch operation in the scroll mode;

FIG. 18 is a diagram illustrating the outline of touch position adjustment; and

FIG. 19 is a diagram illustrating an exemplary sequence of scroll mode release.

### DESCRIPTION OF EMBODIMENTS

In a first embodiment, for example, an operation of touching a button located in the upper side of a screen image is achieved by scrolling down the screen image.

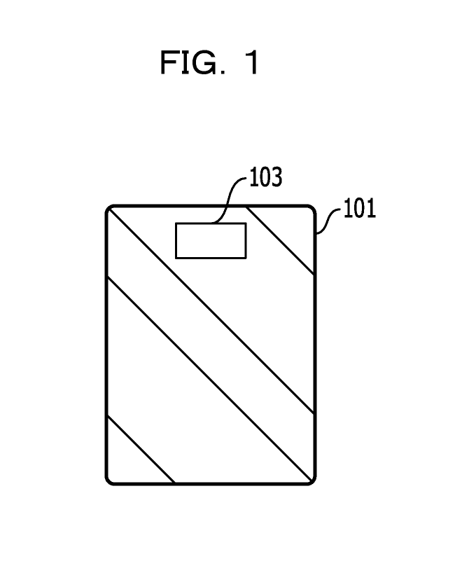

An exemplary operation specification is described below. As illustrated in FIG. 1, in a state in which the screen image 101 is displayed, the user switches the mode of the mobile terminal device to a scroll mode by pressing a certain key so as to scroll down the screen image 101 by drag or flick.

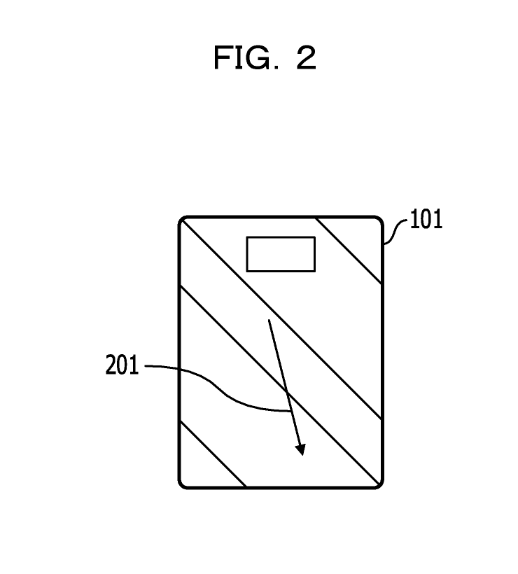

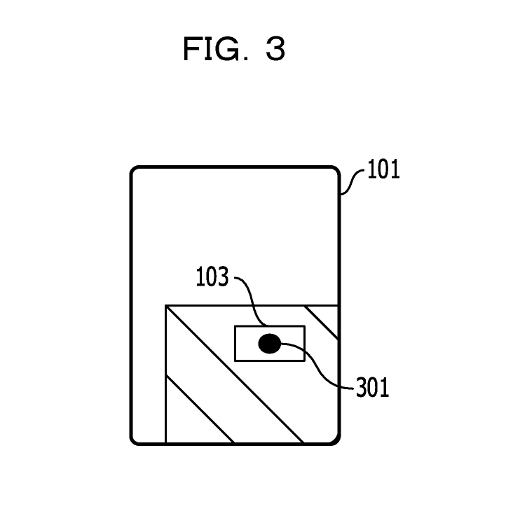

FIG. 2 illustrates an exemplary operation of the mobile terminal device. The arrow in the screen image 101 indicates a movement vector 201 resulted from the drag or flick. When such an operation is performed, the screen image 101 as illustrated in FIG. 3 is displayed. The position of the button 103 is lowered by the scrolling. In such a state, the user touches the button 103. The black dot in the screen image 101 indicates a touch position 301. When the button 103 is touched, or when the above-described certain key is released, the scroll mode is released. The description of the exemplary operation specification is as described above.

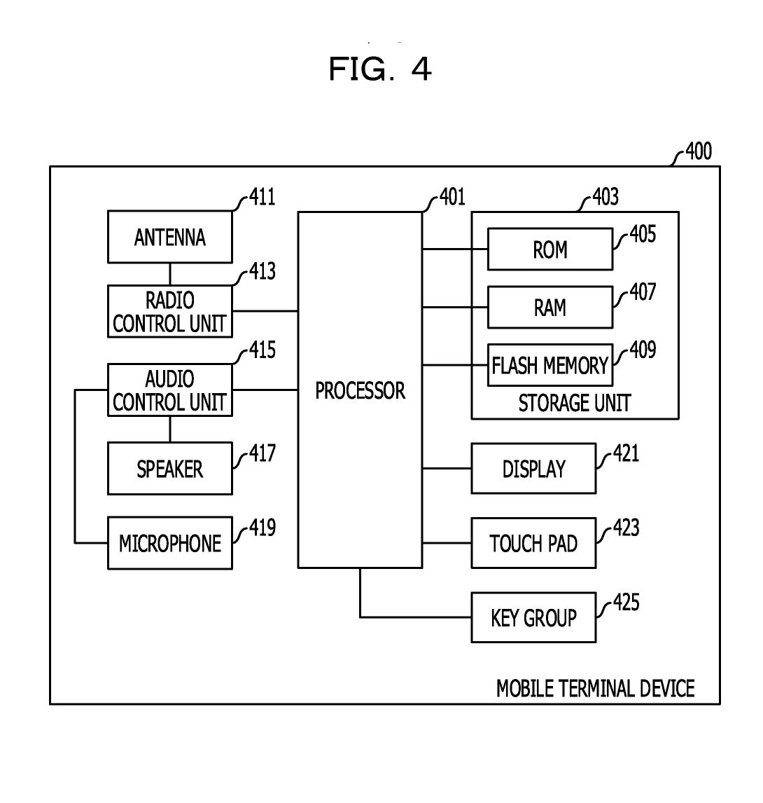

A hardware configuration of the mobile terminal device is described below. FIG. 4 illustrates an exemplary hardware configuration of the mobile terminal device. A mobile terminal device 400 includes a processor 401, a storage unit 403, an antenna 411, a radio control unit 413, an audio control unit 415, a speaker 417, a microphone 419, a display 421, a touch pad 423, and a key group 425.

The processor 401 may include a modem central processing unit (CPU) and an application CPU. The storage unit 403 includes, for example, a read-only memory (ROM) 405, a random access memory (RAM) 407, and a flash memory 409. The ROM 405 stores, for example, a program such as an application program. The RAM 407 includes, for example, a memory area in which the program such as the application program and data such as the screen image are stored. The flash memory 409 stores, for example, user data.

The touch pad 423 is, for example, a panel-like sensor that is provided on a surface of the display 421, and accepts an instruction through the user operation. The display 421 displays, for example, various screen images that are caused to be displayed by application processes. Specifically, the display 421 is used as a touch panel that is obtained by integrating a liquid crystal display and the touch pad 423. The touch pad 423 is an example of a position input device. Each key in the key group 425 is provided in a part of the housing of the mobile terminal device 400. The key may be provided in any one of the front surface, back surface, side surface, top surface, and bottom surface. The key group 425 includes a key that is used for an instruction to switch the mode to the scroll mode in the first embodiment. For example, when it is assumed that the user performs the operation with the right hand, the certain key may be provide on a left side surface in order to operate the certain key with the ring finger or middle finger.

The antenna 411 receives wireless data, for example, through a cellular system, a wireless local area network (LAN), a near field communication system, or the like. The radio control unit 413 controls wireless communication. Audio communication with a telephone and data communication with a mail are performed by the control of the wireless communication.

The audio control unit 415 performs analog/digital conversion and digital/analog conversion on audio data. The speaker 417 outputs analog data as sound. The microphone 419 converts sound into analog data.

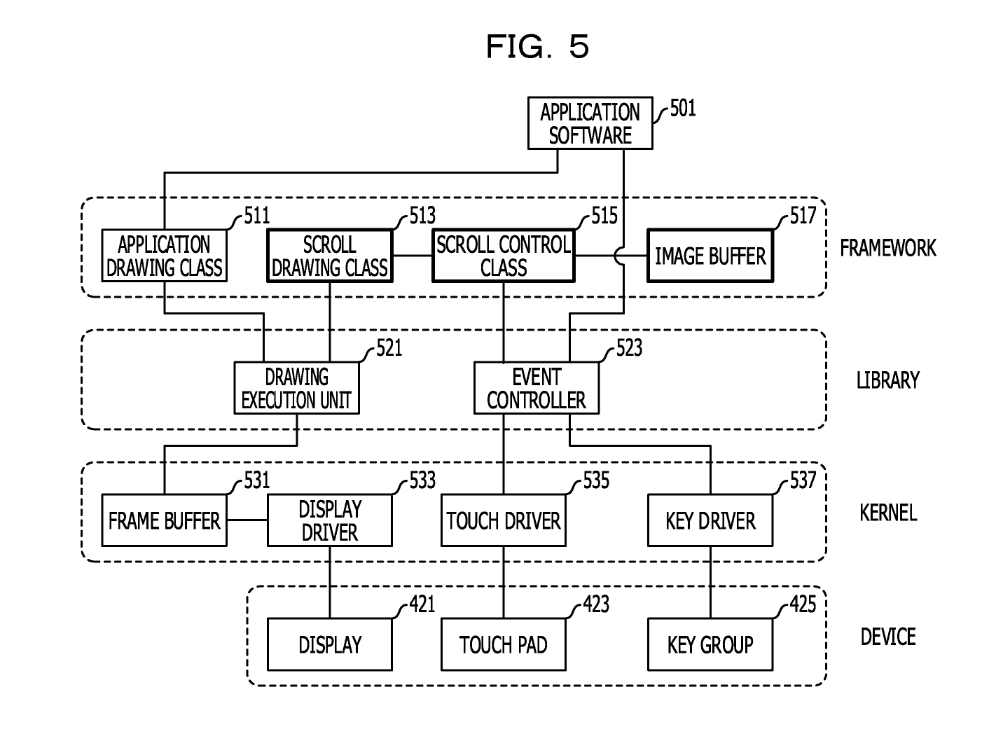

A functional configuration of the mobile terminal device is described below. FIG. 5 illustrates an exemplary functional configuration of the mobile terminal device. Hereinafter, a function that is obtained by executing software such as a program is also simply referred to as “software”. The mobile terminal device includes application software 501, an application drawing class 511, a scroll drawing class 513, a scroll control class 515, an image buffer 517, a drawing execution unit 521, an event controller 523, a frame buffer 531, a display driver 533, a touch driver 535, and a key driver 537.

The application drawing class 511, the scroll drawing class 513, the scroll control class 515, and the image buffer 517 are included in a framework. The drawing execution unit 521 and the event controller 523 are included in a library. The frame buffer 531, the display driver 533, the touch driver 535, and the key driver 537 are included in a kernel. The display 421, the touch pad 423, and the key group 425 are devices.

The application software 501 is an example of a program that is used to generate a screen image to be displayed on the display 421. The application software 501 uses the application drawing class 511 in order to display the screen image. The application drawing class 511 provides a command of screen image drawing function for the application software 501. The application drawing class 511 delivers screen image to the drawing execution unit 521 in accordance with a certain interface. The drawing execution unit 521 stores the screen image in the frame buffer 531. The display driver 533 displays the screen image stored in the frame buffer 531 on the display 421.

The event controller 523 obtains operation information on the touch pad 423 from the touch driver 535, and raises an event related to a touch pad operation. The event related to the touch pad operation includes, for example, “touch”, “drag”, and “flick”. The event controller 523 further obtains operation information on the key group 425 from the key driver 537, and raises an event related to a key operation. The event related to the key operation includes, for example, “key-down” and “key-up”. The event controller 523 notifies a notification destination that is set beforehand of the event. In the normal mode, it is set that an event from the touch driver 535 is notified to the application software 501, and an event related to a certain key operation is notified to the scroll control class 515. In the scroll mode, switching is performed so that the event from the touch driver 535 is notified to the scroll control class 515.

The scroll drawing class 513, the scroll control class 515, and the image buffer 517 that are indicated by the heavy line are provided for the scroll mode in the first embodiment. The scroll control class 515 is achieved in another process that is different from the process of the application software 501.

Therefore, dealing with the scroll mode may not be performed on the application software 501 side.

The scroll control class 515 may be achieved in a process that is the same as the process of the application software 501.

The scroll control class 515 controls the operation in the scroll mode. The scroll drawing class 513 provides a command of screen image drawing function for the scroll control class 515. The scroll drawing class 513 delivers the screen image to the drawing execution unit 521 in accordance with a certain interface. The scroll control class 515 uses the image buffer 517 when the screen image is saved temporarily. The image buffer 517 stores therein the screen image temporarily.

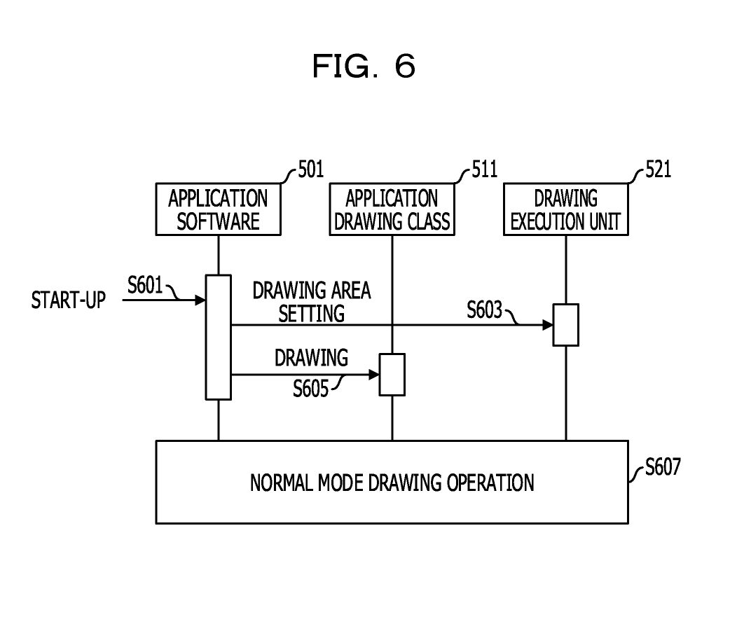

An operation of the mobile terminal device 400 is described below. First, the operation in the normal mode is described. FIG. 6 illustrates an exemplary sequence of normal mode start-up. When the application software 501 is started up (S601), a drawing area is set to the drawing execution unit 521 (S603). The drawing area is a memory area that is used for drawing. The drawing area is provided, for example, in the RAM 407. The set drawing area is an interface that is used to deliver the screen image from the application drawing class 511 to the drawing execution unit 521. The setting of the drawing area in S603 allows the drawing execution unit 521 to obtain the screen image from the application drawing class 511.

The application software 501 writes the screen image to a buffer prepared by the application drawing class 511 and calls a drawing function prepared by the application drawing class 511 (S605). In the normal mode drawing operation (S607), the drawing operation in the normal mode is performed.

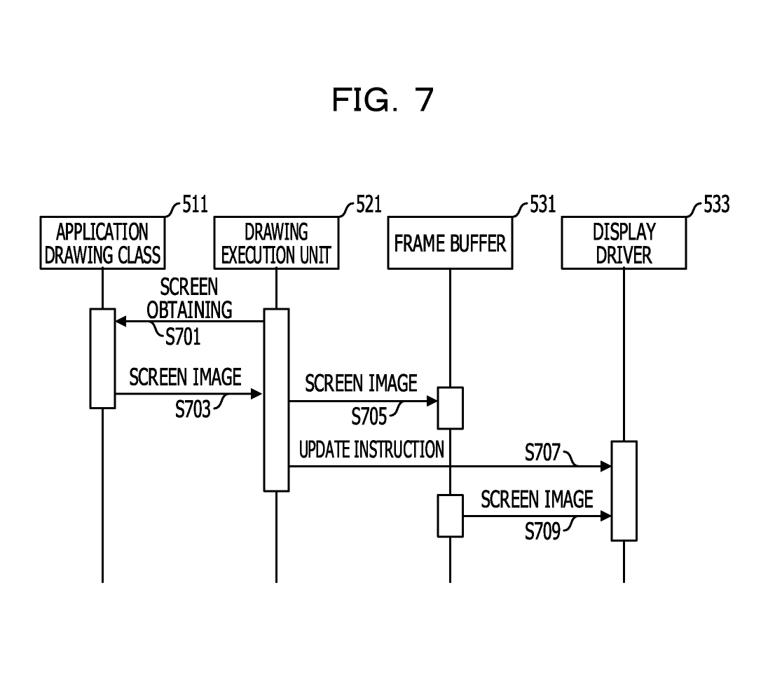

FIG. 7 illustrates an exemplary sequence of a drawing operation in the normal mode. The drawing execution unit 521 calls a screen obtaining function that is prepared by the application drawing class 511 (S701). The application drawing class 511 delivers the screen image to the drawing execution unit 521 (S703). The drawing execution unit 521 writes the delivered screen image to the frame buffer 531 (S705). When the drawing execution unit 521 issues an update instruction to the display driver 533 (S707), the display driver 533 displays the screen image stored in the frame buffer 531 on the display 421 (S709). In the normal mode, the above-described drawing operation is repeated. As described above, the screen image that is generated by the application software 501 is displayed on the display 421.

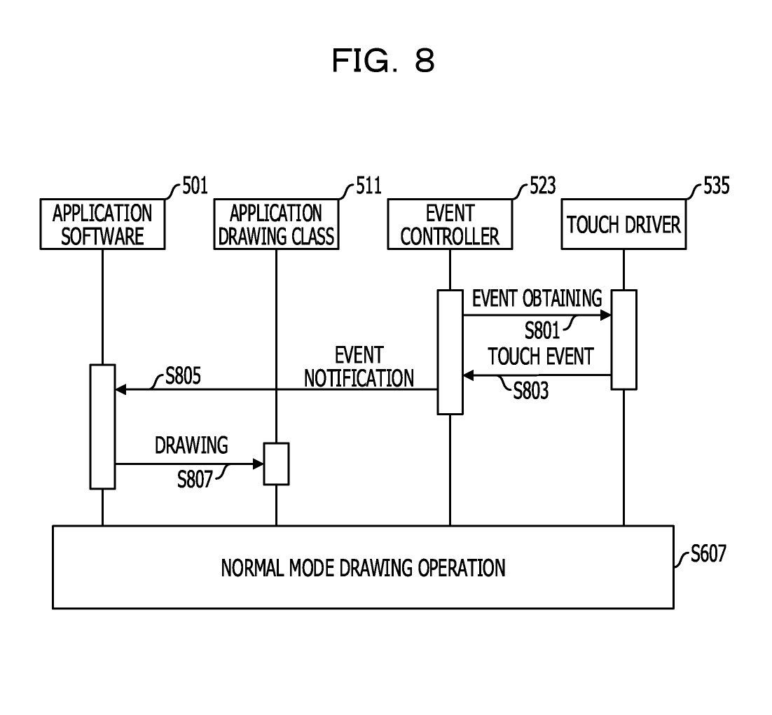

A touch operation in the normal mode is described below. FIG. 8 illustrates an exemplary sequence of the touch operation in the normal mode. The event controller 523 operates so as to obtain an event from the touch driver 535 (S801). When the event controller 523 obtains a touch event from the touch driver 535 (S803), the event controller 523 notifies the application software 501 of the event (S805). The application software 501 executes processing in response to the event. When the screen image is updated in the processing, the application software 501 generates the screen image, writes the screen image to the buffer prepared by the application drawing class 511, and calls the drawing function prepared by the application drawing class 511 (S807). Then, the screen image that is updated in the above-described normal mode drawing operation (S607) is displayed.

The description of the operation in the normal mode is as described above. An operation in the scroll mode is described below.

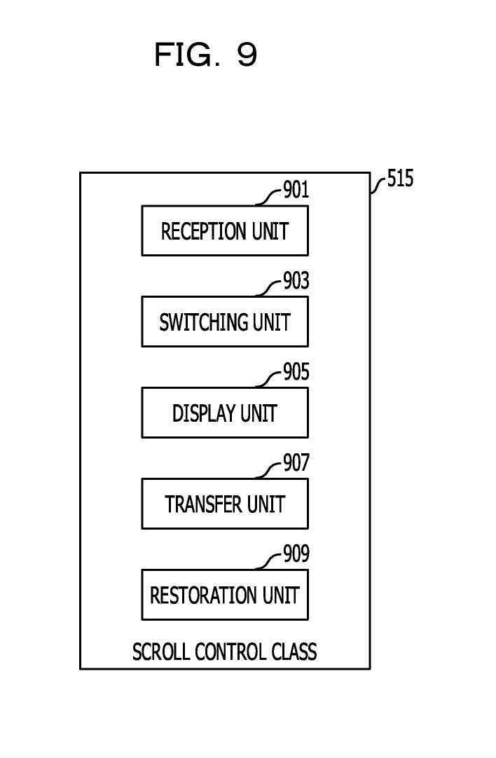

FIG. 9 illustrates an exemplary configuration of the above-described scroll control class 515. The scroll control class 515 includes a reception unit 901, a switching unit 903, a display unit 905, a transfer unit 907, and a restoration unit 909. The reception unit 901 mainly accepts an event from the event controller 523. The switching unit 903 mainly switches a drawing area and an event notification destination. The display unit 905 mainly performs display by scroll. The transfer unit 907 mainly adjusts a touch event and transfers the adjusted touch event to the application software 501. The restoration unit 909 mainly restores the drawing area and the event notification destination.

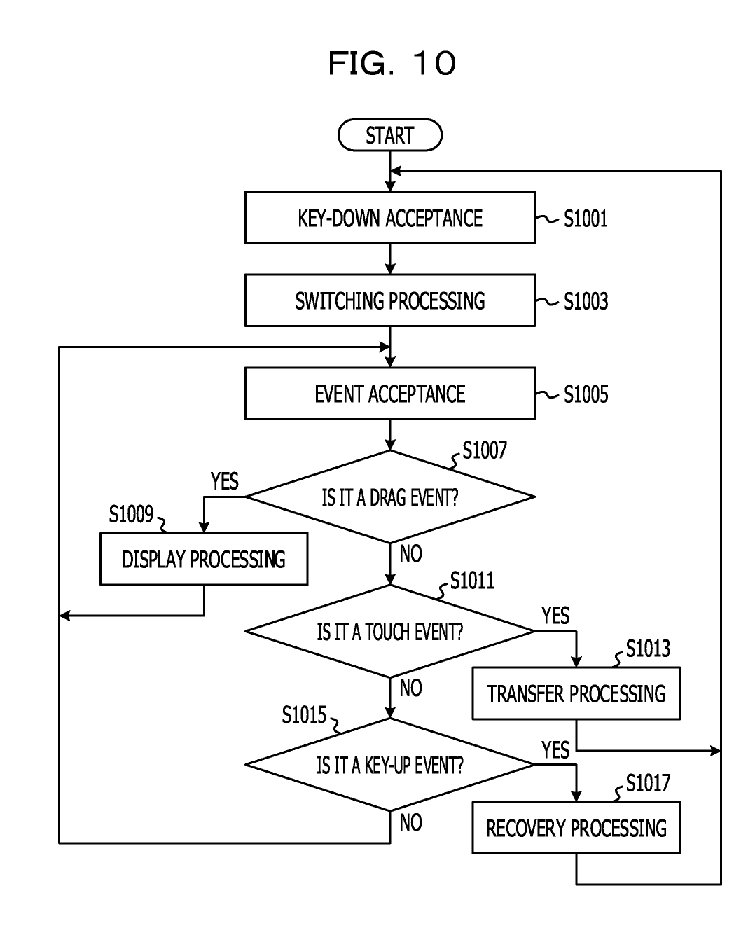

The outline of processing by the scroll control class 515 is described below. FIG. 10 illustrates an exemplary flow of a scroll control processing. The reception unit 901 waits and accepts a key-down event for a certain key (S1001). When the key-down event for the certain key is accepted, the switching unit 903 executes switching processing (S1003).

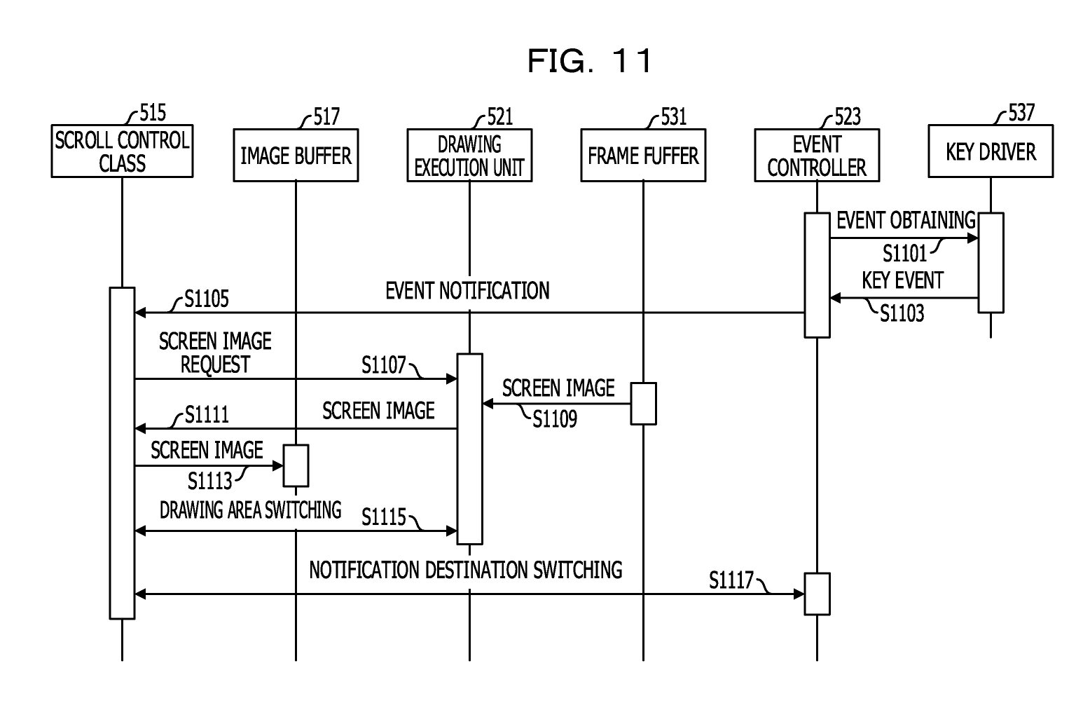

The processing of S1001 and the processing of S1003 are described using the exemplary sequence of the scroll mode start-up illustrated in FIG. 11. The event controller 523 operates so as to obtain an event from the key driver 537 (S1101). When the event controller 523 obtains the key event for the certain key from the key driver 537 (S1103), the key event is notified to the scroll control class 515 (S1105). The event controller 523 is set beforehand so that the key event for the certain key is notified to the scroll control class 515.

The reception unit 901 of the scroll control class 515 accepts the key event and executes the following processing when the reception unit 901 determines that the key event corresponds to “key-down”. Such processing corresponds to the key-down acceptance of S1001 illustrated in FIG. 10.

The scroll control class 515 operates so as to save the currently displayed screen image temporarily. Therefore, the switching unit 903 of the scroll control class 515 requests the screen image to the drawing execution unit 521 (S1107). The drawing execution unit 521 reads the screen image stored in the frame buffer 531 (S1109) and transfers the read screen image to the scroll control class 515 (S1111).

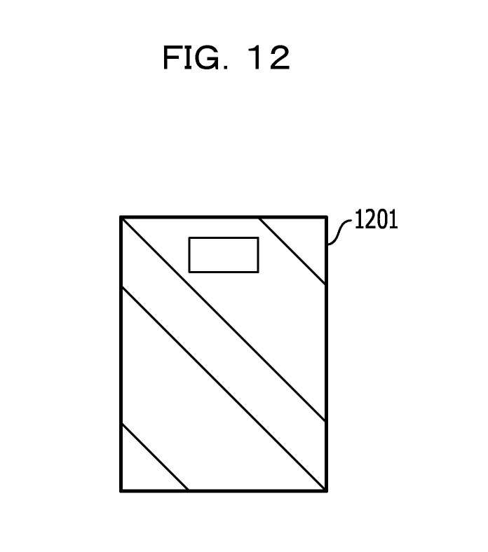

FIG. 12 illustrates an example of a screen image 1201 that is stored in the frame buffer 531. The screen image 1201 is an original data that is displayed as the screen image 101 illustrated in FIG. 1.

Returning to the description of the processing illustrated in FIG. 11, the switching unit 903 of the scroll control class 515 stores the transferred screen image in the image buffer 517 (S1113).

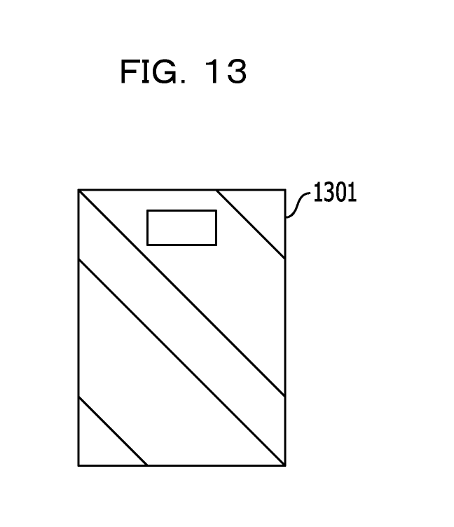

FIG. 13 illustrates an example of a screen image 1301 that is stored in the image buffer 517. The screen image 1301 is the same as the screen image 1201 illustrated in FIG. 12.

Returning to the description of the processing illustrated in FIG. 11, the switching unit 903 of the scroll control class 515 causes the drawing execution unit 521 to switch the drawing area (S1115). Instead of the drawing area that is set by the application software 501 in S603 of FIG. 6, a new drawing area is set in the scroll control class 515. This allows the drawing execution unit 521 to obtain the screen image from the scroll drawing class 513. At that time, the scroll control class 515 obtains information regarding the original drawing area from the drawing execution unit 521 and holds the obtained information temporarily. When the original drawing area is identified by another method, such temporary holding processing may be omitted. The scroll control class 515 holds the upper left coordinates of the screen image that is displayed in the drawing area as drawing origin point coordinates, and initializes such value to the upper left coordinates of the drawing area.

The switching unit 903 of the scroll control class 515 causes the event controller 523 to switch the event notification destination (S1117). Specifically, the switching is performed so that the event from the touch driver 535 is notified to the scroll control class 515. At that time, the scroll control class 515 obtains the original notification destination from the event controller 523, and holds the obtained original notification destination temporarily. When the original notification destination is identified by another method, such temporary holding processing may be omitted. The description of the sequence of the scroll mode start-up is as described above.

Returning to the description of the processing illustrated in FIG. 10, when the switching processing (S1003) is terminated, the reception unit 901 waits for acceptance of an event. When the event is accepted (S1005), the display unit 905 determines whether or not the accepted event corresponds to “drag” (S1007). When it is determined that the accepted event corresponds to “drag”, the display unit 905 executes display processing (S1009).

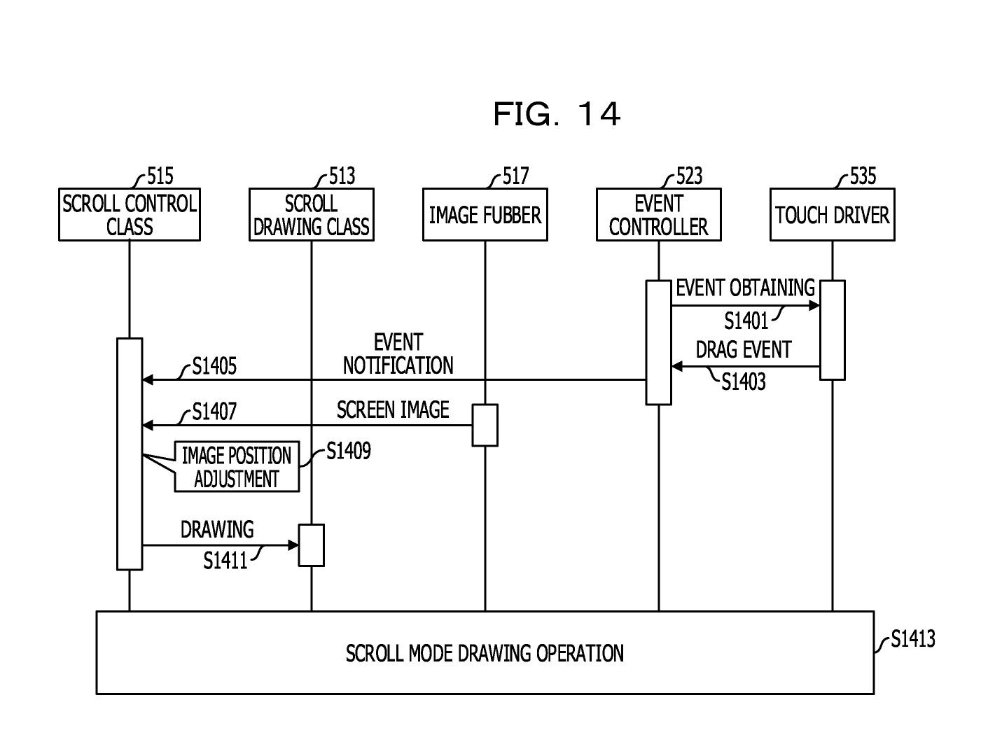

The processing of S1007 and the processing of S1009 are described using the exemplary sequence of the scroll operation in the scroll mode illustrated in FIG. 14. The event controller 523 operates so as to obtain an event from the touch driver 535 (S1401). When the event controller 523 obtains the drag event from the touch driver 535 (S1403), the corresponding event is notified to the scroll control class 515 (S1405). The drag event is notified to the scroll control class 515 because the notification destination is changed in S1117 illustrated in FIG. 11. The reception unit 901 of the scroll control class 515 accepts the drag event. Such processing corresponds to the event acceptance of S1005 illustrated in FIG. 10. When it is determined in S1007 that the event accepted by the reception unit 901 corresponds to “drag”, the following processing is executed. The display unit 905 of the scroll control class 515 reads the screen image from the image buffer 517 (S1407), and adjusts the position of the image (S1409).

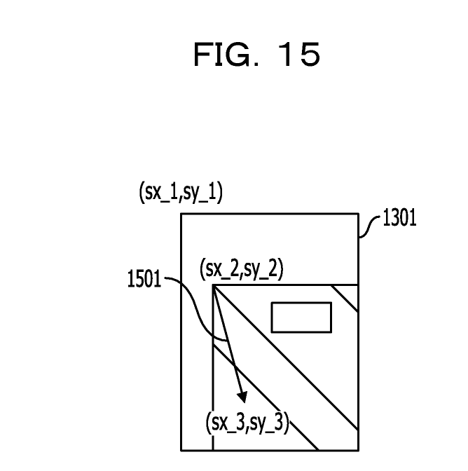

The outline of the image position adjustment of the image is described using FIG. 15. Coordinates (sx_3, sy_3) of a new drawing origin point are obtained by shifting coordinates (sx_2, sy_2) of a current drawing origin point in accordance with a movement vector (dx, dy). That is, coordinates of the new drawing origin point are calculated in accordance with formulas “sx_3=sx_2+dx” and “sy_3=sy_2+dy”. The coordinates (sx_2, sy_2) of the current drawing origin point are initialized to coordinates (sx_1, sy_1) at the upper left corner when the mode is switched into the scroll mode. In FIG. 15, the arrow indicates a movement vector 1501. The movement vector 1501 corresponds to a movement vector 201 illustrated in FIG. 2.

Returning to the description of the processing illustrated in FIG. 14, the display unit 905 of the scroll control class 515 generates a screen image, writes the screen image to the buffer prepared by the scroll drawing class 513, and calls the drawing function prepared by the scroll drawing class 513 (S1411). In the scroll mode drawing operation (S1413), the drawing operation in the scroll mode is performed.

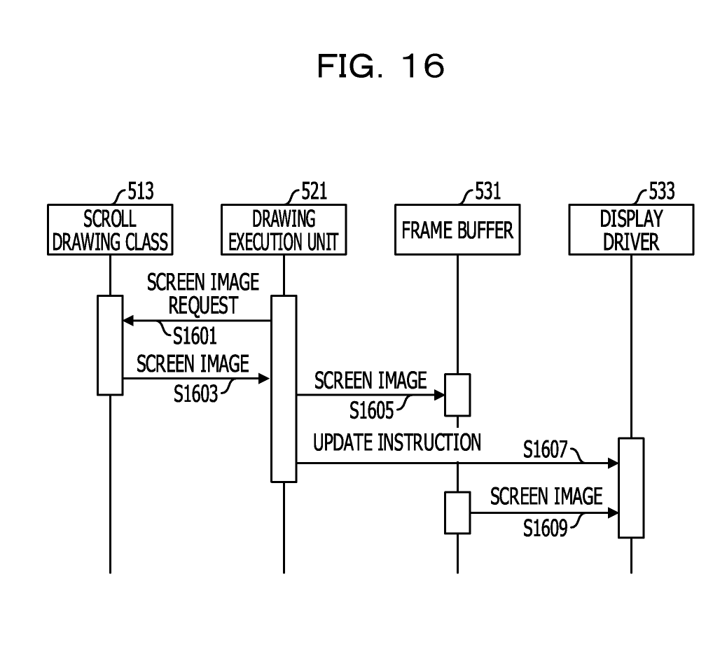

FIG. 16 illustrates an exemplary sequence of the drawing operation in the scroll mode. The drawing execution unit 521 calls the screen obtaining function that is prepared by the scroll drawing class 513 (S1601). The scroll drawing class 513 delivers the screen image to the drawing execution unit 521 (S1603). At that time, the scroll drawing class 513 delivers, to the drawing execution unit 521, the screen image that is obtained by moving the whole image so that the upper left corner corresponds to the drawing origin point. The drawing execution unit 521 writes the screen image to the frame buffer 531 similarly to the processing of S705 illustrated in FIG. 7 (S1605). The drawing execution unit 521 issues an update instruction to the display driver 533 similarly to the processing of S707 illustrated in FIG. 7 (S1607). The display driver 533 displays the screen image that is stored in the frame buffer 531 on the display 421 similarly to the processing of S709 illustrated in FIG. 7 (S1609). As described above, the screen image illustrated in FIG. 3 is displayed. In the scroll mode, the above-described drawing operation is repeated.

The description of the sequence of the scroll mode start-up and the sequence of the scroll mode drawing operation is as described above.

Returning to the description of the processing illustrated in FIG. 10, when the display processing (S1009) is terminated, the flow returns to the processing of S1005. When the display processing is repeated by a plurality of times, generated movement vectors are combined each time.

When it is determined in S1007 that the event does not correspond to “drag”, the transfer unit 907 determines whether or not the event accepted in S1005 corresponds to “touch” (S1011). When it is determined that the event accepted in S1005 corresponds to “touch”, the transfer unit 907 executes the transfer processing (S1013).

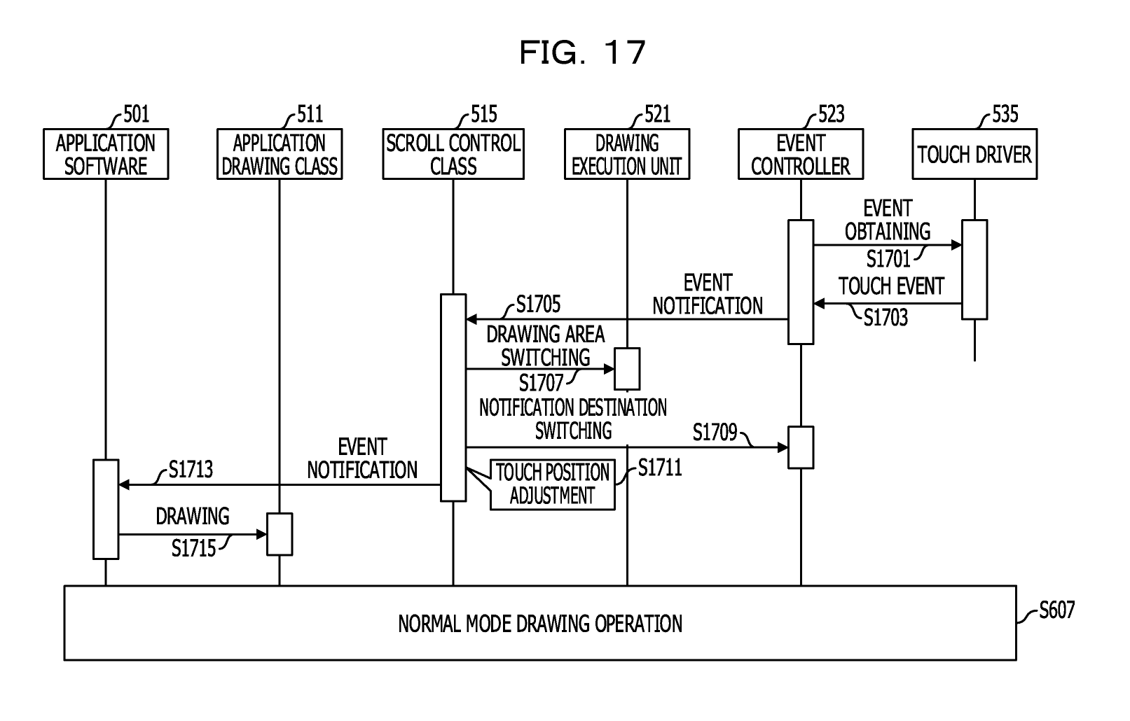

The processing of S1011 and the processing of S1013 are described using the exemplary sequence of the touch operation in the scroll mode illustrated in FIG. 17. The event controller 523 operates so as to obtain an event from the touch driver 535 (S1701). When the event controller 523 obtains the touch event from the touch driver 535 (S1703), the event is notified to the scroll control class 515 (S1705). The touch event is notified to the scroll control class 515 because the notification destination is changed in S1117. The reception unit 901 of the scroll control class 515 accepts the touch event. Such processing corresponds to the event acceptance of S1005 illustrated in FIG. 10. When it is determined in S1011 that the event accepted by the reception unit 901 corresponds to “touch”, the following processing is executed.

In order to switch the mode from the scroll mode to the normal mode, the transfer unit 907 of the scroll control class 515 causes the drawing execution unit 521 to switch the drawing area (S1707). Specifically, the drawing area is returned to the original drawing area. As a result, the scroll mode drawing operation ends, and the normal mode drawing operation starts.

The transfer unit 907 of the scroll control class 515 causes the event controller 523 to switch the event notification destination (S1709). Specifically, it is set that the event from the touch driver 535 is notified to the original notification destination.

As a result, an instruction to terminate the scroll mode after the touch operation has been performed is not desired. The operation is performed easily by releasing the scroll mode automatically.

The transfer unit 907 of the scroll control class 515 performs adjustment of the touch position (S1711).

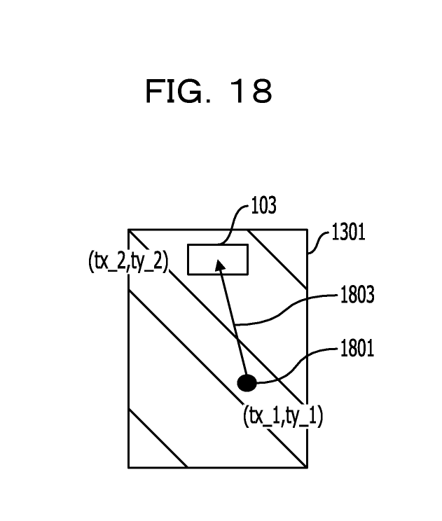

The outline of adjustment of a touch position 1801 is described using FIG. 18. Coordinates (tx_2, ty_2) of the touch position that corresponds to the original screen are obtained by subtracting the movement vector (dx, dy) from coordinates (tx_1, ty_1) of the touch position that is included in the touch event. That is, coordinates of the position, on the original screen, corresponding to the touch position 1801 are calculated in accordance with formulas “tx_2=tx_1−dx” and “ty_2=ty_1−dy”. The arrow illustrated in FIG. 18 indicates an inverse vector 1803 of the movement vector. The inverse vector 1803 of the movement vector corresponds to the opposite direction of the movement vector 201 illustrated in FIG. 2 and has the same size as the movement vector 201. In this example, the inverse vector 1803 of the movement vector indicates the location of the button 103 of the original screen.

Returning to the description of the processing illustrated in FIG. 17, the transfer unit 907 of the scroll control class 515 notifies the application software 501 of the touch event that is obtained by adjusting the touch position (S1713). The application software 501 executes processing in response to the touch event. When the screen image is updated in the processing, the application software 501 generates a new screen image, writes the screen image to the buffer prepared by the application drawing class 511, and calls the drawing function prepared by the application drawing class 511 (S1715). Then, the new screen image is displayed by the above-described normal mode drawing operation (S607). The description of the sequence of the touch operation in the scroll mode is as described above.

Returning to the description of the processing illustrated in FIG. 10, when the transfer processing (S1013) is completed, the flow returns to the processing of S1001.

When it is determined in S1011 that the event does not correspond to “touch”, the restoration unit 909 determines whether or not the event accepted in S1005 corresponds to “key-up” for the certain key (S1015). When it is determined that the event corresponds to “key-up” for the certain key, the restoration unit 909 executes restoration processing (S1017).

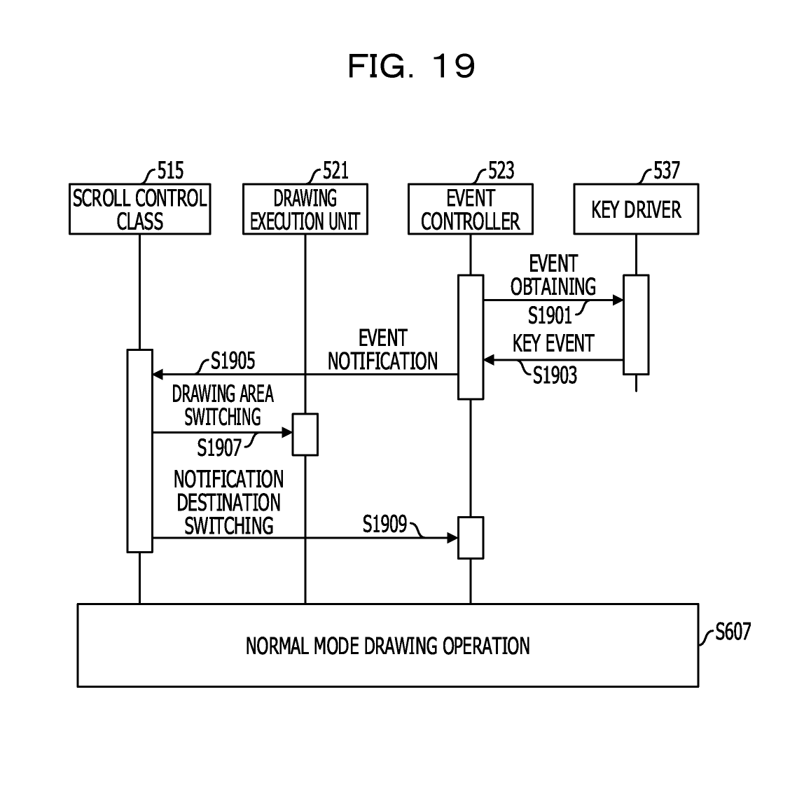

The processing of S1015 and the processing of S1017 are described using the exemplary sequence of scroll mode release illustrated in FIG. 19. The event controller 523 operates so as to obtain an event from the key driver 537 (S1901). When the event controller 523 obtains the key event for the certain key from the key driver 537 (S1903), the key event is notified to the scroll control class 515 (S1905). The reception unit 901 of the scroll control class 515 accepts the key event. Such processing corresponds to the event acceptance of S1005 illustrated in FIG. 10. When it is determined in S1015 that the event accepted by the reception unit 901 corresponds to “key-up”, the following processing is executed.

In order to switch the mode from the scroll mode to the normal mode, the restoration unit 909 of the scroll control class 515 causes the drawing execution unit 521 to switch the drawing area (S1907). Specifically, the drawing area is returned to the original drawing area.

The restoration unit 909 of the scroll control class 515 causes the event controller 523 to switch the event notification destination (S1909). Specifically, it is set that the event accepted from the touch driver 535 is notified to the original notification destination. After that, the normal mode drawing operation is performed (S607). The description of the sequence of scroll mode release is as described above.

Returning to the description of the processing illustrated in FIG. 10, when the restoration processing (S1017) is completed, the flow returns to the processing of S1001. When it is determined that the event does not correspond to “key-up” for the certain key in S1015, the flow returns to the processing of S1005. In this case, the scroll mode is continued.

The example of scroll by drag is described above, however, the first embodiment may also be applied to a case of scroll by flick. In this case, the processing is executed so that a drag event is replaced with a flick event. In addition, the processing may be executed so as to be compatible with both of the scroll by drag and the scroll by flick.

In the above-described example, the example is described in which the scroll mode is started up by “key-down” for a certain key, and the scroll mode is released by “key-up” for the certain key, but a toggle-type key event may be used. For example, the scroll mode is started up by first key pressing, and the scroll mode is released by second key pressing.

In addition, when the user touches a certain icon that is included in the screen image, the scroll mode may be started up. In addition, when the user touches the certain icon that is included in the screen image, the scroll mode may be released.

As the example of the information processing apparatus, the example of the mobile terminal device is described, but the first embodiment may be applied to an information processing apparatus that is not portable.

In the first embodiment, a screen image is scrolled so that a touch operation on the screen is performed. Thus, an icon and the like that are arranged at a position that it is difficult for the user to touch may be touched easily.

The first embodiment is described above, but embodiments are not limited to the first embodiment. For example, the function blocks in the above-described functional configuration may not correspond to the actual modules in the program module configuration.

The configuration of the storage areas described above is merely an example, and not limited to such an example. The order of the pieces of processing may be interchanged in the processing flow as long as the processing result is not changed. In addition, some pieces of processing may be executed in parallel.

The outline of the embodiments described above is as follows.

A control program causes an information processing apparatus to execute the following procedure: (A) causes an event controller to switch a notification destination of an event raised in response to a touch panel operation, from a first process to a second process, when an instruction for switching to a scroll mode is accepted. The first process is run by execution of an application program that is related to a screen image currently displayed on a touch panel. The second process is run by execution of the control program; (B) displays the screen image at a shifted position when the event notified from the event controller corresponds to a drag event or a flick event. The shifted position is obtained by the second process by shifting an original display position in accordance with a movement vector resulted from the drag or flick; and (C) causes an adjusted touch event to be transferred to the first process when the event notified from the event controller is a touch event. The adjusted touch event is obtained by adjusting the notified touch event such that a touch position that is included in the notified touch event is modified based on the movement vector.

As a result, the screen image is scrolled so that a touch operation on the screen is performed. Thus, an icon and the like that are arranged at a position that it is difficult for the user to touch may be touched easily.

In addition, the event controller is caused to switch the notification destination of the event, and the adjusted touch event is transferred to application software (application program that is related to the screen image currently displayed on the touch panel), so that dealing with the scroll mode is not desired on the application software side.

When the event notified from the event controller corresponds to the touch event, processing of restoring the notification destination of an event may be performed.

As a result, after the touch operation is performed, an instruction to terminate the scroll mode is not desired. The operation is performed easily by releasing the scroll mode automatically.

The above-described switching instruction may correspond to an event raised in response to a key operation.

As a result, an icon and the like that are used to perform switching to the scroll mode may not be provided in the screen image. Thus, any screen layout may be employed.

A program that causes a processor to execute the processing by the above-described method may be prepared, and the program may be stored, for example, in a computer-readable storage medium or storage device such as a flexible disk, a compact disc-read-only memory (CD-ROM), a magneto-optical disk, a semiconductor memory, and a hardware disk. An intermediate processing result is generally stored in a storage device such as a main memory temporarily.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a control program for causing an information processing apparatus including a touch panel to execute a procedure, the procedure comprising:
causing, upon accepting a switching instruction, an event controller to switch a notification destination from a first process to a second process, the switching instruction being an instruction for switching a mode of the information processing apparatus to a scroll mode, the notification destination being a destination to which a panel event is to be notified of, the panel event being raised in response to an operation on the touch panel, the first process being run by execution of an application program that is related to a screen image currently displayed on the touch panel, the second process being run by execution of the control program;
displaying, upon being notified of a movement event from the event controller, the screen image on the touch panel, the movement event being a panel event raised in response to an operation of dragging or flicking on the touch panel, the shifted position being obtained by shifting an original position in accordance with a movement vector resulted from the movement event, the original position being a position at which the screen image is currently displayed on the touch panel; and
transferring, upon being notified of a first touch event from the event controller, a second touch event to the first process, the first touch event being a panel event raised in response to an operation of touching the touch panel, the second touch event being obtained by adjusting the first touch event such that a touch position included in the first touch event is modified based on the movement vector.

2. The computer-readable recording medium according to claim 1, the procedure further comprising:
causing, upon being notified of the first touch event, the event controller to restore the notification destination.

3. The computer-readable recording medium according to claim 1, wherein the switching instruction corresponds to a key event raised in response to an operation on a key.

4. An information processing apparatus comprising:
a touch panel; and
a processor configured to
cause, upon accepting a switching instruction, an event controller to switch a notification destination from a first process to a second process, the switching instruction being an instruction for switching a mode of the information processing apparatus to a scroll mode, the notification destination being a destination to which a panel event is to be notified of, the panel event being raised in response to an operation on the touch panel, the first process being run by execution of an application program that is related to a screen image currently displayed on the touch panel, the second process being run by execution of a control program,
display, upon being notified of a movement event from the event controller, the screen image at a shifted position on the touch panel, the movement event being a panel event raised in response to an operation of dragging or flicking on the touch panel, the shifted position being obtained by shifting an original position in accordance with a movement vector resulted from the movement event, the original position being a position at which the screen image is currently displayed on the touch panel, and
transfer, upon being notified of a first touch event from the event controller, a second touch event to the first process, the first touch event being a panel event raised in response to an operation of touching the touch panel, the second touch event being obtained by adjusting the first touch event such that a touch position included in the first touch event is modified based on the movement vector.

5. A control method of an information processing apparatus, the control method comprising:
causing by the information processing apparatus, upon accepting a switching instruction, an event controller to switch a notification destination from a first process to a second process, the switching instruction being an instruction for switching a mode of the information processing apparatus to a scroll mode, the notification destination being a destination to which a panel event is to be notified of, the panel event being raised in response to an operation on a touch panel, the first process being run by execution of an application program that is related to a screen image currently displayed on the touch panel, the second process being run by execution of a control program;
displaying, upon being notified of a movement event from the event controller, the screen image at a shifted position on the touch panel, the movement event being a panel event raised in response to an operation of dragging or flicking on the touch panel, the shifted position being obtained by shifting an original position in accordance with a movement vector resulted from the movement event, the original position being a position at which the screen image is currently displayed on the touch panel; and
transferring, upon being notified of a first touch event from the event controller, a second touch event to the first process, the first touch event being a panel event raised in response to an operation of touching the touch panel, the second touch event being obtained by adjusting the first touch event such that a touch position included in the first touch event is modified based on the movement vector.
